(19) United States
(12) Patent Application Publication
(10) Pub. No.: US 2013/0254512 A1
(43) Pub. Date: Sep. 26, 2013

(54) MEMORY MANAGEMENT METHOD AND INFORMATION PROCESSING DEVICE

(71) Applicant: Akira Takeda, Kanagawa (JP)

(72) Inventor: Akira Takeda, Kanagawa (JP)

(73) Assignee: KABUSHIKI KAISHA TOSHIBA, Tokyo (JP)

(21) Appl. No.: 13/614,141

(22) Filed: Sep. 13, 2012

(30) Foreign Application Priority Data
Mar. 23, 2012 (JP) 2012-068192

(51) Int. Cl. G06F 12/02; G06F 12/10

(52) U.S. Cl. 711/171; 711/E12.002; 711/E12.061

(57) ABSTRACT

According to one embodiment, a memory management method implemented by a computer includes managing each block of a memory region included in the computer based on a buddy allocation algorithm. The method includes managing a correspondence relation between a virtual address and a physical address of one block using one entry of a page table. Each block has a size of a super page. The method includes allocating an empty first block to a process so that the number of empty blocks does not exceed the number of empty entries of a translation look-aside buffer (TLB).

### CROSS-REFERENCE TO RELATED APPLICATIONS

This application is based upon and claims the benefit of priority from Japanese Patent Application No. 2012-068192, filed on Mar. 23, 2012; the entire contents of which are incorporated herein by reference.

### FIELD

Embodiments described herein relate generally to a memory management method and an information processing device.

### BACKGROUND

A processor that includes a memory management unit (MMU) supporting only a single page size consumes a lot of translation look-aside buffer (TLB) entries for a bunch of memory regions involving consecutive addresses. As a result, a TLB miss occurs, and a performance of the processor is degraded. Accordingly, a recent MMU supports a plurality of page sizes.

### BRIEF DESCRIPTION OF THE DRAWINGS

FIG. 1 is a configuration diagram of an information processing device according to an embodiment of the invention;

FIG. 2 is a diagram illustrating an aspect in which a virtual memory space of 32 KB is allocated and deallocated by a buddy system;

FIG. 3 is a diagram illustrating an aspect in which a memory region is reserved by a technology according to a comparative example;

FIG. 4 is a diagram illustrating a state of a memory region and a progress of the number of consumed entries of a TLB when an allocation and a deallocation are performed by a technology according to a comparative example;

FIG. 5 is a diagram illustrating a state of a memory region and a progress of the number of consumed entries of a TLB when an allocation and a deallocation are performed by a technology according to a comparative example;

FIG. 6 is a flowchart illustrating an operation of an information processing device when allocating a memory region;

FIG. 7 is a flowchart illustrating an operation of an information processing device when deallocating a memory region;

FIG. 8 is a flowchart illustrating an operation of an information processing device when collecting a page frame that is not being used;

FIG. 9 is a diagram illustrating a state of a memory region and a progress of the number of consumed entries of a TLB in an information processing device of the embodiment;

FIG. 10 is another configuration diagram of an information processing device according to an embodiment of the invention; and

FIG. 11 is still another configuration diagram of an information processing device according to an embodiment of the invention.

### DETAILED DESCRIPTION

In general, according to one embodiment, a memory management method implemented by a computer includes managing each block of a memory region included in the computer based on a buddy allocation algorithm. The method includes managing a correspondence relation between a virtual address and a physical address of one block using one entry of a page table. Each block has a size of a super page. The method includes allocating an empty first block to a process so that the number of empty blocks does not exceed the number of empty entries of a translation look-aside buffer (TLB).

Exemplary embodiments of a memory management method and an information processing device will be explained below in detail with reference to the accompanying drawings. The present invention is not limited to the following embodiments.

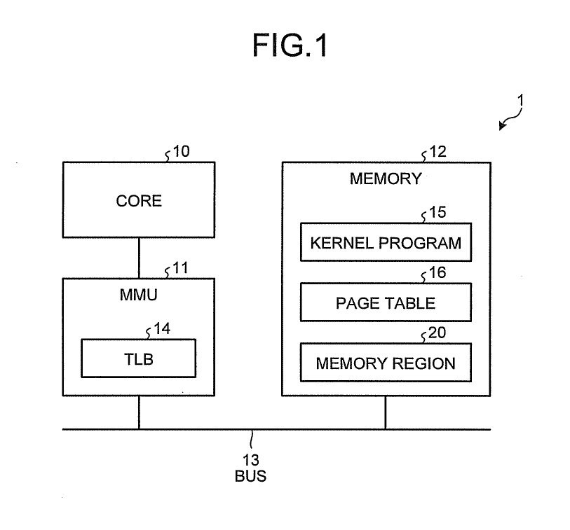

FIG. 1 is a configuration diagram explaining an information processing device according to an embodiment of the invention. An information processing device 1 includes a core (processor core) 10, an MMU 11, a memory 12, and a bus 13. The memory 12 is connected to the bus 13. The core 10 is connected to the bus 13 via the MMU 11. Here, a network topology that connects the core 10, the MMU 11, and the memory 12 to one another is not limited to a bus system. The information processing device 1 of the embodiment may employ another network topology such as a mesh.

The memory 12 stores a kernel program 15 in advance. Further, the memory 12 includes a memory region 20 that may be allocated to a process. The kernel program 15 (hereinafter, simply referred to as a kernel 15) manages the core 10. The kernel 15 is executed by the core 10, and allocates a portion of the memory region 20 or the entire memory region 20 to a process executed in the core 10. Here, the process refers to the memory region 20 by using a virtual address. The kernel 15 registers a virtual address, paired with a physical address of the memory 12, of a region allocated to a process in a page table 16 when performing a memory allocation. Hereinafter, a registration of an entry in the page table 16 is simply referred to as mapping.

The MMU 11 is a unit that processes access from the core 10 to the memory 12. The MMU 11 includes a TLB 14 that caches a predetermined number of entries in the page table 16. When an entry related to a virtual address requested from the core 10 is cached in the TLB 14, the MMU 11 exchanges the virtual address for a physical address using the entry, and accesses the physical address acquired through the exchange. When an entry, related to a virtual address, required from the TLB 14 is not cached in the TLB 14, that is, when a TLB miss occurs, the MMU 11 searches for the entry with reference to the page table 16. In this way, since the TLB miss entails a process of referring to the page table 16, it is preferable that a TLB miss be reduced as possible. Here, all entries of the TLB 14 are switched concurrently with a switch of a process executed by the core 10.

Further, the kernel 15 manages the memory region 20. Here, a buddy system (buddy allocation algorithm) is employed as a memory management algorithm. According to the buddy system, all empty pages are managed as a block constructed by pages of which the number is consecutive powers of two. When consecutive pages are requested to be allocated from a process, the kernel 15 rounds up the number of pages to be allocated so that the number of requested pages is a power of two. Then, the kernel 15 searches for a block corresponding to the number of pages that is rounded up. When a block of a size to be allocated is found, the buddy system allocates all pages within the block to a user. When the block is not found, the kernel 15 finds a block of a relatively large size, and divides the block into two blocks of the same size. The two blocks of the same size generated as described in the foregoing are referred to as mutual buddy blocks. The kernel 15 selects one of the mutual buddy blocks, continues division until a block size becomes a size corresponding to the number of pages to be allocated, and allocates all pages included in the block to a process when a size of the block generated through the division matches the size corresponding to the number of pages to be allocated. When deallocating an allocated page, the kernel 15 combines empty buddy blocks, and merges the empty buddy blocks into a block of a double size. It is determined that two empty blocks are mutual buddy blocks when the following three conditions are satisfied.

(1) Two blocks have the same size.

(2) Two blocks are consecutive in a physical address space.

(3) A beginning address of a block formed by combining two blocks is aligned by a size of the block formed by combining two blocks.

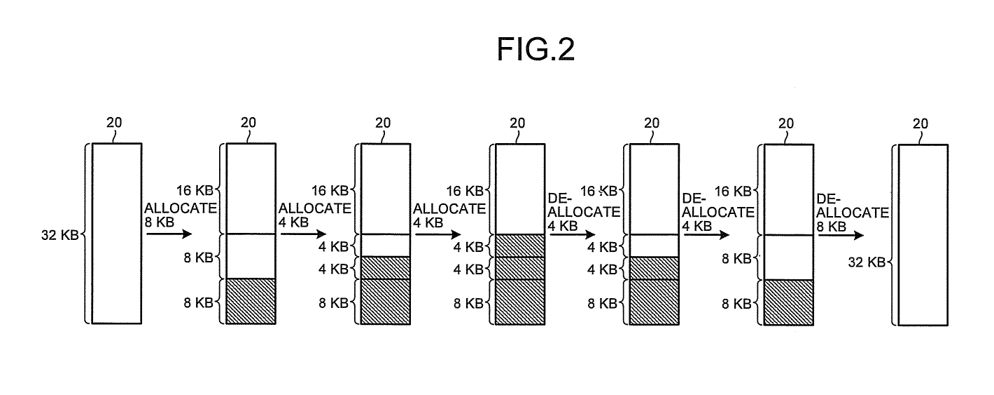

FIG. 2 is a diagram illustrating an aspect in which a virtual memory space of 32 KB is allocated and deallocated by a buddy system. In this example, a page size is 1 KB. In an initial state, a buddy system includes a block that includes 32 empty pages. When 8 KB, that is, 8 pages are requested from a user (process), a block corresponding to the 8 pages does not found, and thus the buddy system divides a block corresponding to 32 pages included in the buddy system into two blocks corresponding 16 pages. Further, the buddy system selects one block, and divides the one block into two blocks corresponding to 8 pages. The buddy system allocates one of two blocks corresponding to 8 pages to the user. When the user further requests 4 KB, that is, 4 pages, the buddy system divides the remaining block corresponding to 8 pages into two blocks, and allocates one of the two blocks to the user. When 4 KB is further requested, the buddy system allocates the other block corresponding to 4 pages. Thereafter, when 4 KB is requested to be deallocated, the buddy system investigates whether the deallocated block corresponding to 4 pages may be combined. In this case, since a block of the same size is absent, the block may not be combined. Thereafter, in a case where the user further requests 4 KB to be deallocated, since the block corresponding to 4 pages deallocated before one instance is present, the buddy system combines the block with the block deallocated this time to form a block corresponding to 8 pages. Further, when 8 KB is requested to be deallocated, the buddy system combines blocks corresponding to 8 pages, and combines the formed block corresponding to 16 pages with a block corresponding to 16 pages that is already present to finally form a block corresponding to 32 pages.

Here, in the embodiment, the MMU 11, the TLB 14, and the page table 16 support a plurality of page sizes. In other words, each entry constituting the TLB 14 and the page table 16 indicates a region of a size which is a power of two times a page size. In this way, a block that is under control of the buddy system may be designated by a single entry rather than a plurality of entries for each page, and thus entry consumption of the TLB 14 may be reduced. As a result, a TLB miss may be decreased. Hereinafter, a region of a size greater than that of a base page (here, a region of a size which is a power of two times a page size) is referred to as a super page. Further, a region of a page size may be referred to as a base page. Hereinafter, it is presumed that a page includes not only a base page but also a super page. A beginning address of a page indicated by each entry is aligned by a size of the page.

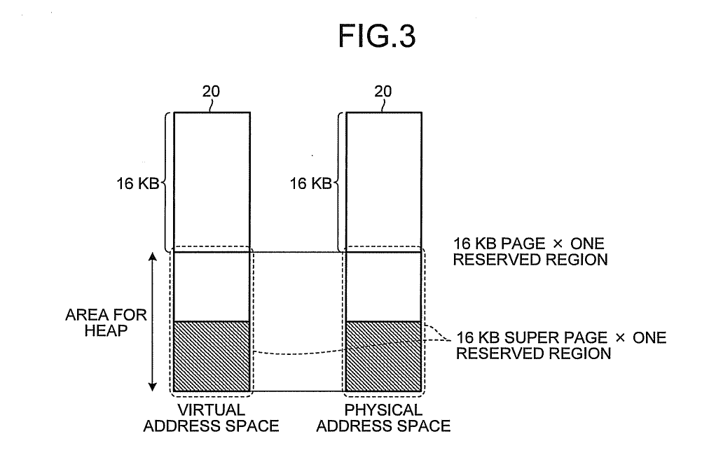

Here, a technology compared with the embodiment of the invention (hereinafter, referred to as a technology according to a comparative example) is described. FIG. 3 is a diagram illustrating an aspect in which a memory region is reserved by a technology according to a comparative example. According to the technology related to the comparative example, when a memory region of 8 KB is requested to be allocated, it is determined that the requested memory region is more likely to be accessed after the requested memory region for a heap area. Then, consecutive regions corresponding to 16 KB (a portion surrounded by a dotted line) which is greater than a requested size is reserved. Thereafter, when most of the reserved consecutive regions is accessed or mapped, a mapped page is merged, and the reserved consecutive regions are mapped as a 16 KB page once again.

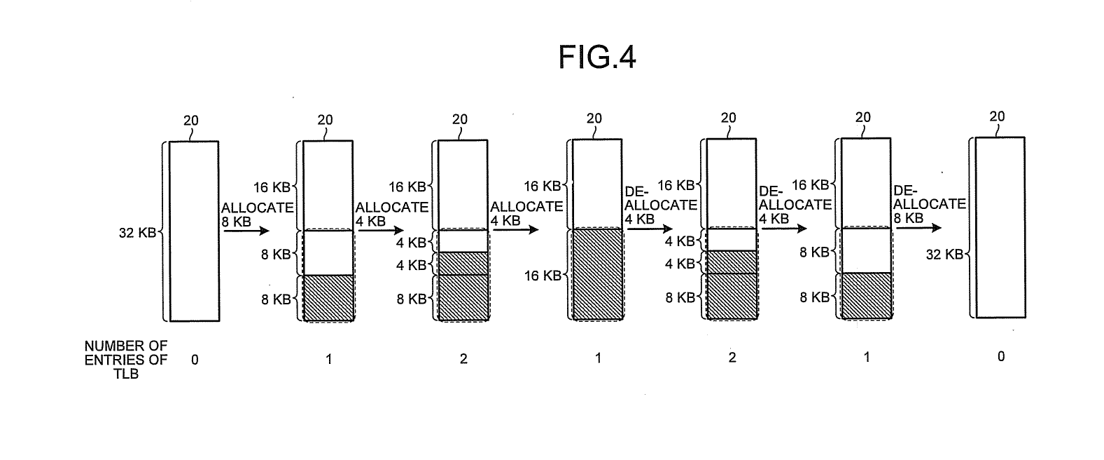

FIG. 4 is a diagram illustrating a state of the memory region 20 and a progress of the number of consumed entries of the TLB 14 when an allocation and a deallocation are performed by a technology according to a comparative example. In FIG. 4, the number of consumed entries of the TLB 14 is described under the memory region 20. According to the technology related to the comparative example, when 8 KB is initially requested to be allocated, a kernel reserves 16 KB consecutive regions, and maps an 8 KB page. Then, thereafter, when two consecutive requests for 4 KB to be allocated respectively are preformed, and the entire reserved region is accessed, the kernel merges an 8 KB page with two 4 KB pages, and maps the pages as a 16 KB page again.

However, according to the technology related to the comparative example, the kernel determines whether to reserve consecutive regions corresponding to a super page based on whether it is more likely to access most of reserved consecutive regions later. When it is determined that a reserve is not necessary, the kernel performs a mapping in a base page (or a small super page) as before.

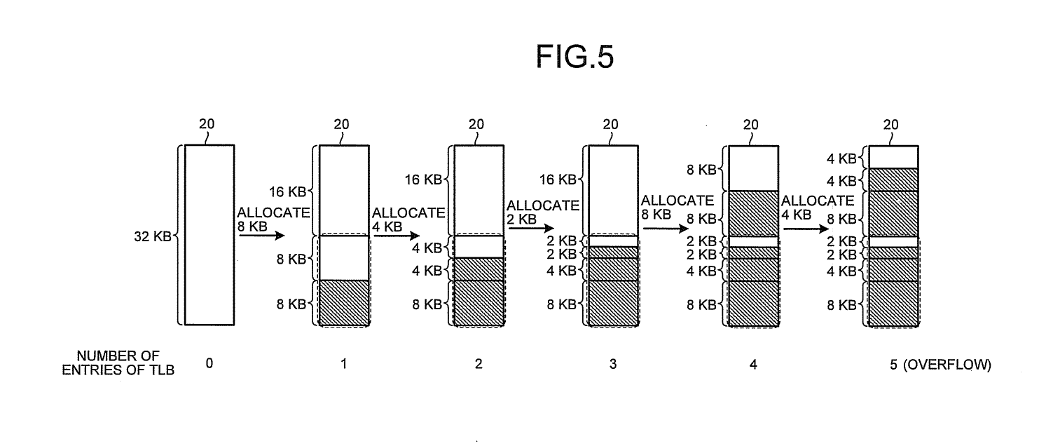

FIG. 5 is another diagram illustrating a state of a memory region and a progress of the number of consumed entries of the TLB 14 when an allocation and a deallocation are performed by a technology according to a comparative example. Here, it is presumed that the TLB 14 may cache up to four entries. When requests for 8 KB, 4 KB, 2 KB, 8 KB, and 4 KB memory regions to be allocated are performed in this order, and a region reservation is not performed, as illustrated in FIG. 5, in response to responding to the fifth request, the number of necessary entries of the TLB 14 becomes 5, and the TLB 14 overflows. This occurs since a reservation is not performed, and thus a process of merging a small page with a large page is not performed, and accordingly the number of necessary entries is increased. Here, according to the technology related to the comparative example, even when a reservation is performed, a mergence of a page is not performed unless a condition in which most of a reserved region is accessed or mapped is satisfied.

In the embodiment, to prevent the TLB 14 from overflowing, the kernel 15 performs a reservation and a mergence of consecutive regions corresponding to a super page based on the number of empty entries of the TLB 14.

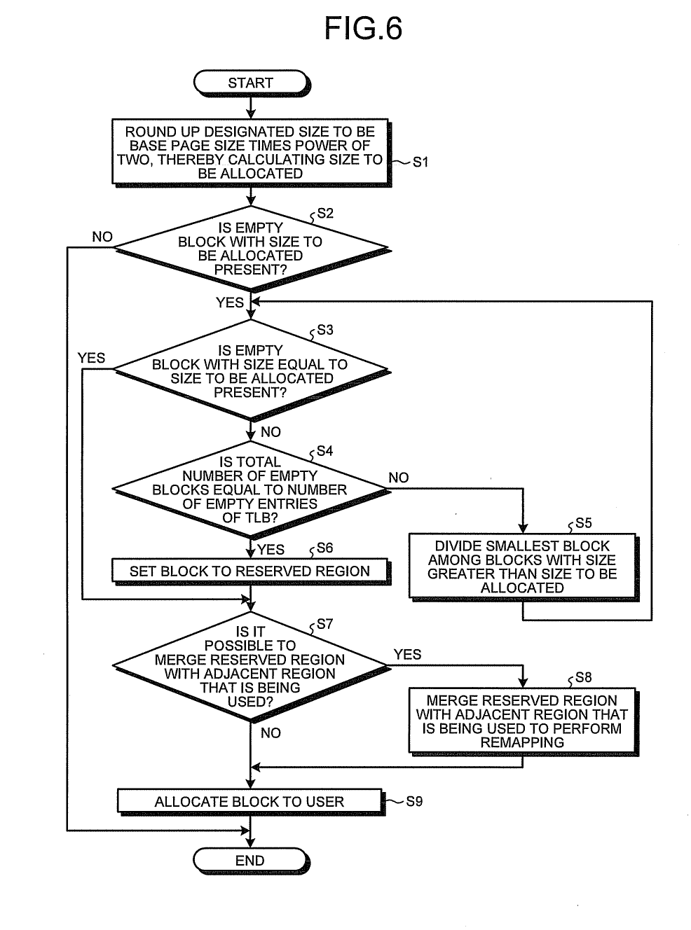

FIG. 6 is a flowchart illustrating an operation of the information processing device 1 when allocating a memory region. When a memory region is requested to be allocated, the kernel 15 rounds up a size designated by a request to be a base page size times a power of two in accordance with a rule of a buddy system, thereby calculating a size to be allocated (S1). Then, the kernel 15 determines whether a block of a size greater than or equal to the size to be allocated is present (S2). When the block of a size greater than or equal to the size to be allocated is absent (No in S2), the kernel 15 ends the operation without allocating a memory region.

When the block of a size greater than or equal to the size to be allocated is present (Yes in S2), the kernel 15 determines whether a block of a size equal to the size to be allocated is present (S3). When the block of a size equal to the size to be allocated is absent (No in S3), the kernel 15 determines whether the total number of empty blocks is equal to the number of empty entries of the TLB 14 (S4). When the total number of empty blocks is not equal to the number of empty entries of the TLB 14 (No in S4), that is, when the total number of empty blocks is smaller than the number of empty entries of the TLB 14, the kernel 15 divides the smallest block among blocks of a size greater than the size to be allocated in accordance with the rule of the buddy system (S5). Then, the kernel 15 performs the determining process of S3 again.

When an empty block is divided, the total number of empty blocks exceeds the number of empty entries of the TLB 14. Thus, when the entire blocks are allocated to the same process thereafter, a TLB miss may occur. Therefore, when the total number of empty blocks is equal to the number of empty entries of the TLB 14 (Yes in S4), the kernel 15 sets the smallest block among blocks of a size greater than the size to be allocated to a reserved region (S6).

In this way, since the kernel 15 divides an empty block so that the number of empty blocks does not exceed the number of empty entries of the TLB 14, it is guaranteed that the number of entries of the TLB 14 corresponding to a memory region allocated to a process does not exceed the maximum number of entries of the TLB. Further, when the total number of empty blocks is less than the number of empty entries of the TLB 14, the kernel 15 divides an empty block.

Subsequently, the kernel 15 determines whether a set reserved region may be merged with an adjacent memory region that is being used (S7). The kernel 15 determines that two memory regions (a reserved region and an adjacent memory region that is being used) may be merged into a memory region when all of the three conditions below are satisfied, and determines that it is difficult to merge memory regions when at least one of the three conditions is not satisfied.

(4) Two memory regions are adjacent to each other in both of a virtual address space and a physical address space.

(5) Two memory regions have the same size.

(6) A virtual address and a physical address at a beginning of a super page after a mergence are concurrently aligned by a size of the super page after the mergence.

When two memory regions may be merged together (Yes in S7), the kernel 15 merges the two memory regions together to perform a remapping as a memory region of a super page (S8). Then, the kernel 15 allocates a memory region of a super page generated through the remapping to a user (S9), and ends the operation. When two memory regions may not be merged together (No in S7), the kernel 15 allocates a reserved region to a user in S9, and ends the operation. Here, when a process of S9 is performed after undergoing the No process of S7, the kernel 15 maps the reserved region.

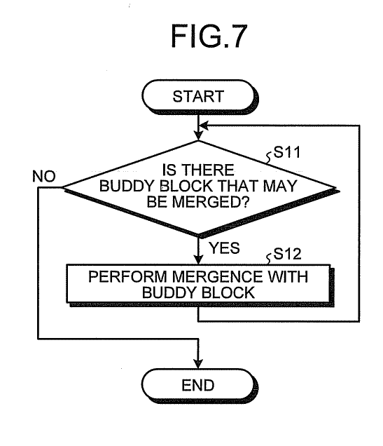

FIG. 7 is a flowchart illustrating an operation of the information processing device 1 when deallocating a memory region. When a memory region is requested to be deallocated, the kernel 15 determines whether an empty block that may be merged with a memory region to be deallocated in accordance with a rule of a buddy system, that is, a buddy block of a memory region to be deallocated is present, and whether the buddy block is an empty block (S11). When the buddy block is an empty block that is a buddy with the memory region to be deallocated (Yes in S11), the kernel 15 merges the memory region to be deallocated with the empty block that is buddy with the memory region (S12), and performs the determining process of S11 again. Here, when performing the determining process of S11 after undergoing the process of S12, the kernel 15 determines whether a buddy block of a block after a mergence is an empty block. In this way, the kernel 15 repeats a mergence until a buddy block that may be merged disappears, and ends the operation when an empty block that may be merged is absent (No in S11).

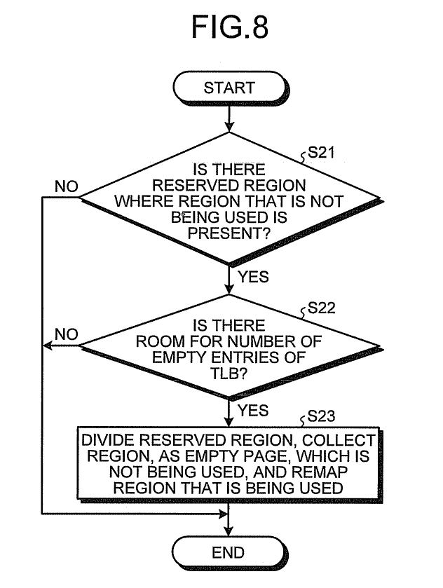

When the kernel 15 reserves consecutive regions, available memory regions decrease by the amount of reservation, and thus a shortage of memory regions may occur at a stage. In this instance, the kernel 15 needs to collect a page frame that is not being used. FIG. 8 is a flowchart illustrating an operation of the information processing device 1 when collecting a page frame that is not being used.

First, the kernel 15 determines whether a memory region that is not being used (accessed or mapped) is present within a reserved memory region (S21). When a memory region that is not being used is absent (No in S21), the kernel 15 ends the operation.

When a memory region that is not being used is present within the reserved region (Yes in S21), the kernel 15 determines whether there is room for the number of empty entries of the TLB 14 (S22). In particular, the kernel 15 determines whether the total number of empty blocks is a value greater than or equal to the number of empty entries of the TLB 14 when the reserved region is divided in accordance with the process of S23 to be described below. When there is room for the number of empty entries of the TLB 14 (Yes in S22), the kernel 15 divides the reserved region in accordance with a rule of a buddy system, collects a region, as an empty block, which is not being used in the reserved region, and remaps a memory region that is being used in the reserved region (S23). When a region that is not being used is absent within the reserved region (No in S21), or when there is no room for the number of empty blocks of the TLB 14 (No in S22), the kernel 15 ends the operation.

Here, the kernel 15 may perform the operation of FIG. 8 at any time in addition to a time when a memory region is insufficient. For example, the operation may be regularly performed. Note that the TLB 14 of a page frame to be collected is an entry of a process to which a memory region to be divided is allocated. To implement this scheme, the kernel 15 may manage the number of empty entries of the TLB 14 corresponding to respective processes for each process.

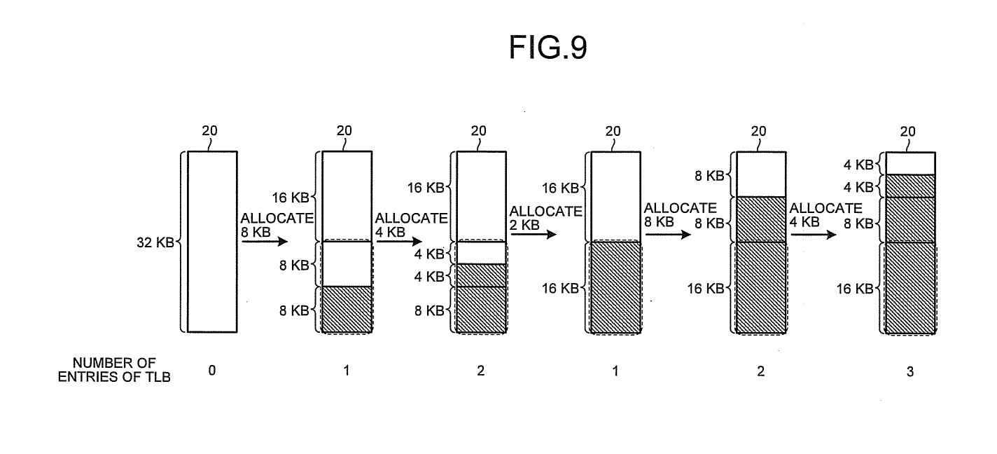

FIG. 9 is a diagram illustrating a state of a memory region and a progress of the number of consumed entries of the TLB 14 in the information processing device 1 of the embodiment. When allocating an initial 8 KB memory region and a 4 KB memory region, the kernel 15 performs an allocation of a page and a mapping in accordance with a rule of a buddy system. Subsequently, when a 2 KB memory region is allocated, the total number of empty blocks is 2, and the number of empty entries is 2, and thus the total number of empty blocks is equal to the number of empty entries. Therefore, the kernel 15 does not further divide an empty block, and set a 4 KB block to a reserved region. Here, since the 4 KB block set to the reserved region may be merged with an allocated 4 KB block that is adjacent to the corresponding block, the kernel 15 merges two blocks into an 8 KB block. Further, since the 8 KB block generated through the mergence may be merged with an allocated 8 KB block that is adjacent to the generated 8 KB block, the kernel 15 merges the two 8 KB blocks to generate a 16 KB block. Finally, the kernel 15 sets the 16 KB block to a reserved region, performs a mapping, and allocates the 16 KB block to a user. Through the reservation and the mergence, even though an 8 KB memory region is requested to be allocated, or a 4 KB memory region is requested to be allocated thereafter, a memory may be allocated without an overflow of an entry of the TLB 14.

Here, in the description above, description has been made on the assumption that the information processing device 1 includes one core 10. However, in the embodiment of the invention, an information processing device including a plurality of cores 10 may be applied.

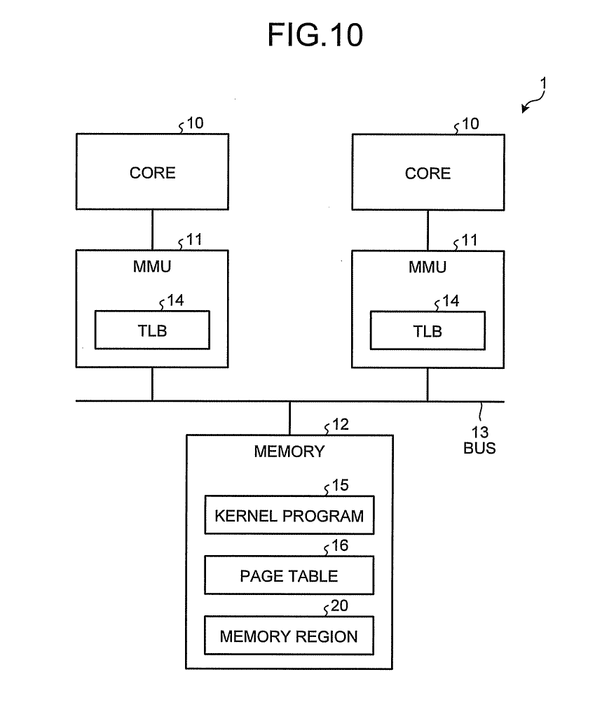

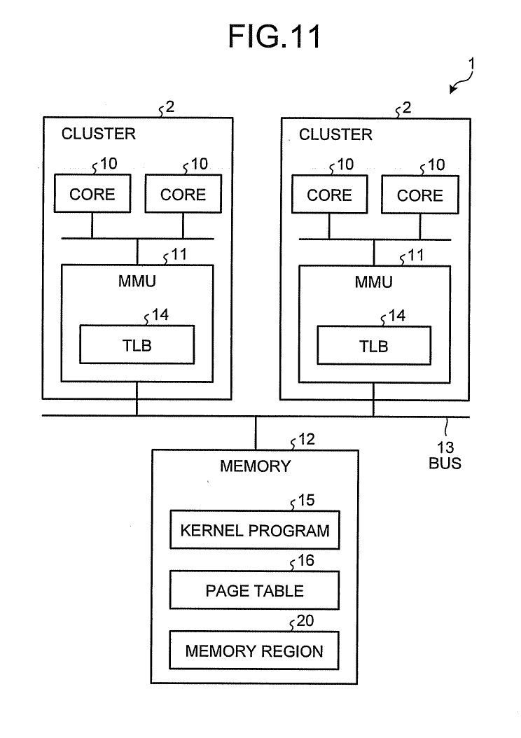

FIGS. 10 and 11 are other configuration diagrams of an information processing device 1 according to an embodiment of the invention. The information processing device 1 illustrated in FIG. 10 includes a plurality of (here, two) cores 10, and includes MMUs 11 for each of the cores 10. Further, the respective MMUs 11 include a TLB 14. In the information processing device 1 of FIG. 10, a kernel 15 allocates and deallocates a memory region based on the number of empty entries of the TLB 14 included in the MMUs 11 connected to the cores 10 requesting an allocation or a deallocation of a memory region. Moreover, the kernel 15 manages the number of empty entries of the TLB 14 included in the respective MMUs 11 for each MMU 11.

An information processing device 1 illustrated in FIG. 11 includes a plurality of (here, two) clusters 2 that include a plurality of (here, two) cores 10 and an MMU 11 that processes access to a memory 12 of the cores 10. In the information processing device 1 of FIG. 11, a kernel 15 allocates and deallocates a memory region based on the number of empty entries of the TLB 14 included in the MMUs 12 that are included in the clusters 2 to which the cores 10 allocating and deallocating a memory region belong. Further, the kernel 15 manages the number of empty entries of the TLB 14 included in the respective clusters 2 for each cluster 2.

In this way, according to the embodiment of the invention, the kernel 15 allocates an empty block to a process so that the number of empty blocks does not exceed the number of empty entries of the TLB 14, and thus it is possible to prevent a TLB miss from occurring.

Further, when a process requests a memory region to be allocated, the kernel 15 divides an empty block so that the number of empty blocks does not exceed the number of empty entries of a TLB to generate an empty block to be allocated (S3 to S6), allocates the empty block to be allocated to the process, and registers an entry describing a correspondence relation between a virtual address and a physical address related to the allocated block in a page table (S9). Accordingly, it is guaranteed that the number of empty blocks does not exceed the number of empty entries of the TLB 14.

Furthermore, the kernel 15 rounds up a size of a memory region requested from a process to be a base page size times a power of two to calculate a first size (S1), determines an empty block of the first size to be an empty block to be allocated (S9) when the empty block of the first size is present (Yes in S3), and determines an empty block of a second size that is greater than the first size to be an empty block to be allocated (S6 and S9) when the empty block of the first size is absent (No in S3), and the total number of empty blocks is equal to the number of empty entries of the TLB (Yes in S4). Accordingly, it is guaranteed that the number of empty blocks does not exceed the number of empty entries of the TLB 14.

Moreover, when the empty block of the first size is absent (No in S3), and the total number of empty blocks is smaller than the number of empty entries of the TLB (No in S4), the kernel 15 divides an empty block of the smallest size (S5). Accordingly, it is guaranteed that the number of empty blocks does not exceed the number of empty entries of the TLB 14.

Further, when an empty block to be allocated may be merged with a block allocated to a process (Yes in S7), the kernel 15 merges the empty block to be allocated with the allocated block to arrange an entry of the TLB (S8). Accordingly, the number of empty blocks may be increased as possible.

Furthermore, when a block of the second size among blocks allocated to a process includes a memory region that is not being used by the process (Yes in S21), the kernel 15 divides a block of the second size so that the number of empty blocks does not exceed the number of empty entries of the TLB, and the memory region that is not being used by the process becomes an empty block, and updates the TLB (S23). Accordingly, it is possible to efficiently use a memory region while inhibiting an occurrence of a TLB miss.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory management method implemented by a computer, the method comprising:
managing each block of a memory region included in the computer based on a buddy allocation algorithm; and
managing a correspondence relation between a virtual address and a physical address of one block using one entry of a page table, each block having a size of a super page,
wherein allocating an empty first block to a process so that the number of empty blocks does not exceed the number of empty entries of a translation look-aside buffer (TLB).

2. The memory management method according to claim 1, further comprising:
generating the empty first block by dividing one empty block so that the number of empty blocks does not exceed the number of empty entries of the TLB when the process requests a memory allocation;
allocating the empty first block to the process; and
registering an entry for the allocated first block to the page table.

3. The memory management method according to claim 2, further comprising
calculating a first size by rounding up a size requested by the process to be a base page size times a power of two, wherein
the generating of the empty first block comprises,
determining, when an empty second block having the first size is present, the empty second block to be the empty first block, and
determining, when the empty second block is absent and when the total number of empty blocks is equal to the number of empty entries of the TLB, an empty third block having a second size that is greater than the first size to be the empty first block.

4. The memory management method according to claim 3, wherein the generating of the empty first block comprises dividing one empty block having the smallest size when the empty second block is absent and when the total number of empty blocks is smaller than the number of empty entries of the TLB.

5. The memory management method according to claim 3, further comprising
when the empty first block is capable of being merged with other block which have been allocated to the process, arranging the TLB by merging the empty first block with the other block.

6. The memory management method according to claim 4, further comprising
arranging the TLB by merging the empty first block with other block which have been allocated to the process.

7. The memory management method according to claim 4, further comprising
when the allocated third block includes a memory region that is not being used by the process, updating the TLB by dividing the allocated third block so that the number of empty blocks does not exceed the number of empty entries of the TLB, and so that the memory region that is not being used by the process becomes an empty block.

8. The memory management method according to claim 5, wherein the generating of the empty first block comprises dividing one empty block having the smallest size when the empty second block is absent and when the total number of empty blocks is smaller than the number of empty entries of the TLB.

9. The memory management method according to claim 6, wherein the generating of the empty first block comprises dividing one empty block having the smallest size when the empty second block is absent and when the total number of empty blocks is smaller than the number of empty entries of the TLB.

10. The memory management method according to claim 3, wherein the second size is a size of an empty block having the smallest size.

11. An information processing device, comprising:
a processor core that executes a process;
a memory that includes a memory region, and stores a page table describing a correspondence relation between a virtual address and a physical address of the memory region allocated to the process; and
a memory management unit that includes a TLB caching an entry related to the memory region allocated to the process in the page table, and processes access to the memory region by the processor core using the TLB, wherein
the processor core
manages the memory by unit of block based on a buddy allocation algorithm, each block having a size of a super page,
manages one entry of the page table for one block, and
allocates an empty first block to the process so that the number of empty blocks does not exceed the number of empty entries of the TLB.

12. The information processing device according to claim 11, wherein the processor core
generates the empty first block by dividing one empty block so that the number of empty blocks does not exceed the number of empty entries of the TLB when the process requests a memory allocation,
allocates the empty first block to the process, and
registers an entry for the allocated first block to the page table.

13. The information processing device according to claim 12, wherein the processor core
calculates a first size by rounding up a size requested by the process to be a base page size times a power of two,
when an empty second block having the first size is present, determines the empty second block to be the empty first block, and
when the empty second block is absent and when the total number of empty blocks is equal to the number of empty entries of the TLB, determines an empty third block having a second size that is greater than the first size to be the empty first block.

14. The information processing device according to claim 13, wherein the processor core divides one empty block having smallest size when the empty second block is absent and when the total number of empty blocks is smaller than the number of empty entries of the TLB.

15. The information processing device according to claim 13, wherein the processor core, when the empty first block is capable of being merged with other block which have been allocated to the process, arranges the TLB by merging the empty first block with the other block.

16. The information processing device according to claim 14, wherein the processor core arranges the TLB by merging the empty first block with other block which have been allocated to the process.

17. The information processing device according to claim 14, wherein the processor core, when the allocated third block includes a memory region that is not being used by the process, updates the TLB by dividing the allocated third block so that the number of empty blocks does not exceed the number of empty entries of the TLB, and so that the memory region that is not being used by the process becomes an empty block.

18. The information processing device according to claim 15, wherein the processor core divides one empty block having smallest size when the empty second block is absent and when the total number of empty blocks is smaller than the number of empty entries of the TLB.

19. The information processing device according to claim 16, wherein the processor core divides one empty block having smallest size when the empty second block is absent and when the total number of empty blocks is smaller than the number of empty entries of the TLB.

20. The information processing device according to claim 13, wherein the second size is a size of an empty block having the smallest size.
